(19) United States
(12) Patent Application Publication
(10) Pub. No.: US 2006/0096317 A1
(43) Pub. Date: May 11, 2006

(54) Method of making hollow glassy and ceramic microspheres, and products made thereby

(76) Inventor: Warren R. Beck, Woodbury, MN (US)

Correspondence Address: Warren R. Beck, 942 Winterberry Drive, Woodbury, MN, 55125, US

(21) Appl. No.: 10/983,318

(22) Filed: Nov. 8, 2004

(51) Int. Cl. C03B 19/10

(52) U.S. Cl. 65/21.4

(57) ABSTRACT

This invention relates to a low cost method of converting solid glass or ceramic microparticles into hollow microspheres by feeding them, along with pulverized coal, into coal-powered furnaces. Coal-powered furnaces generally produce microsized-fused particles of the ash in the coal—called fly ash; and some of the fly ash particles may be hollow. By the present invention the yield of hollow microparticles is greatly increased by co-feeding, along with the pulverized coal, very small amounts of microparticles of inorganic materials known to have the ability to form hollow microspheres upon fusion.

### BACKGROUND

Power plants that use pulverized coal as the combustible energy source produce, as a by-product, microsized fused particles of the ash contained in the coal. These particles generally take the form of glassy microspheres, and are called fly ash. The ash content of coals used for power generation generally varies from around one to ten percent of the weight of the coal. In some modern plants equipped to handle it, the ash content is even up to twenty percent. This ash generally is composed primarily of silica and alumina which average 50% to 60%, and 20% to 25%, respectively, of the weight of the ash. These two components are generally present in the coal, and make up the major portion of the ash. In addition to the alumina and silica, coal ash usually contains a significant amount of iron oxide, which is usually up to a few percent of the ash weight, but can range up to 10% or more. Minor amounts of many other oxides such as the oxides of titanium, calcium, magnesium and potassium, are usually present. These ash compositions are generally good glass formers.

Upon passing through the boiler furnace of a power plant the coal particles burn and the ash content of each particle fuses. This “fly ash” product is usually collected by electrostatic precipitators, and is sold in large tonnages for concrete highway construction, high-rise building construction, and similar uses.

A small fraction of fly ash, usually around one percent of the ash produced, is in the form of hollow microspheres and will float on water. Those power plants which have settling water ponds are able to separate the floating fly ash from the denser fly ash, and recover it as a hollow glass microsphere product which is called “cenospheres.” This product is generally about 0.7 to 0.8 grams per cubic centimeter in average particle density, and is therefore much more valuable than the denser fly ash. It is sold for use as a filler in lightweight products such as plastics, putties, and concrete.

In contrast to the miniscule yield of cenospheres in fly ash the technology of commercial hollow glass microspheres has become advanced enough so that nearly 100% of the particles fed into “bubble” formers will float on water. Hollow microspheres of this type are marketed by a number of companies, and a range of useful compositions for the microspheres has been taught in published literature. Blowing agents are incorporated into the glass so that, when heated above the fusion temperature of the glass, the gas is released to blow the particle into a bubble. These “bubbles” are produced with particle densities much lower than that of cenospheres, and usually average from around 0.4 down to around 0.1 grams per cubic centimeter. They therefore have a much higher market value than cenospheres, and sell for a higher price. These commercial bubbles are generally colorless, in contrast to the usual dark color of cenospheres.

### SUMMARY

My invention is a low cost method of producing hollow microspheres or microbubbles. This is done by feeding glass, ceramic, or mineral bubble-forming precursor microparticles, along with pulverized coal, through coal-burning furnaces. In the furnace the microparticles are subjected to conditions that cause the microparticles to blow into microbubbles. By the invention the yield of hollow microparticles is greatly increased by co-feeding, along with the pulverized coal, very small amounts of microparticles of inorganic materials known to have the ability to form hollow microspheres upon fusion.

In brief summary, my invention is a method of making hollow glassy microspheres by co-feeding into a furnace, along with pulverized coal, microparticles of inorganic, bubble-forming glass, ceramic, or mineral, wherein the co-fed microparticles blow to form microbubbles, and collecting the formed microbubbles.

### DETAILED DESCRIPTION

In carrying out my invention, bubble-forming precursor microparticles are fed, together with pulverized coal, through coal-burning furnaces. In the furnace the microparticles are exposed to heat that raises their temperature above the bubble-blowing temperature, which is generally 1100 degrees C. or more. The microparticles are generally mixed into the pulverized coal when fed into the furnace, though they can also be fed in separately, using conventional feeding mechanisms such as a fluidized bed powder feeder. The mixture of pulverized coal and microparticles enters the combustion chamber of the furnace, often as a fluidized bed in which the coal and microparticles are entrained in air or oxygen. The microparticles are generally not combustible in the conditions experienced, but instead are generally inert except for the expansion and formation of a hollow space or spaces within the microparticle. The conditions for operating the furnace generally need not be changed because of the addition of the bubble-forming microparticles.

The expanded microparticles—i.e. microbubbles (defined as hollow particles having a density less than that of water)—are generally collected with the ash of the furnace combustion process and then conducted to a settling pond, where they float and are collected. Further size and density classification of the floated and collected product can be performed by known techniques, preferably after first drying the product. In general, the microbubbles formed from the added microparticles can have properties, such as size and density, similar to those obtained by passing the microparticles through conventional bubble-forming equipment; conditions of the furnace can be optimized, e.g., by controlling the time-temperature cycle the added microparticles experience in the furnace, to achieve a useful range of properties.

Bubble-forming microparticles can be added to pulverized coal in a variety of proportions. Inclusion in an amount of 1 or 2 percent of the weight of coal will not change the combustion conditions significantly, and can produce up to a 100-fold or more increase in the volume (or weight) of hollow microsphere product. Sufficient precursor particles should be included, e.g., by an intentional addition to the combustible ingredient, to provide economic benefit to collecting and processing the formed bubbles.

I prefer to use as my precursor particles glass compositions of the type made by existing manufacturers of “glass bubbles.” Some examples are those taught in U.S. Pat. Nos. 3,365,315 and 4,391,646. Other possible feed materials may include amber glass, natural minerals such as perlite, or inorganic materials known to have latent gas or gas forming content. These inorganic materials may be called glass-formers, and they have the ability to form hollow glassy microspheres upon fusion. The precursor particles are formulated or selected to include a blowing agent that causes the microparticle to blow into a bubble in the heat of the furnace. The size of microparticles used depends on the size of microbubble to be produced, but generally the microparticles are in a size range of 5 to 50 microns.

Many electric power plants in the U.S. and around the world presently collect and market the fly ash by-product formed by the fusion of the ash in each particle of coal. Coals usually contain at least several percent of ash. Usually around one percent of this fly ash is low enough in density to float on water. It is floated on settling ponds, collected and dried, and sold as “cenospheres”. Commercial cenospheres have average particle densities generally around 0.7 to 0.8 grams per cc. and are sold for high-rise concrete construction and other uses. My proposal is to feed a small amount of bubble forming microparticles, usually 1% to 2% the coal weight. This should result in up to 100-fold increase in hollow microsphere yield, and its density should be significantly lower than the presently produced cenospheres. With proper feed material, the true density could be reduced to 0.4 or lower.

My process will result in a lower cost, lower density by-product than presently marketed cenospheres. Because the only capital expense needed is that for a feeder to admix the raw microparticles with the pulverized coal, and the yield should be higher, and the density lower, the product would sell for a higher price. The profit margin would be greatly increased. Selling price would likely be several times that for present cenospheres.

What is claimed is:

1. Method of making hollow glassy microspheres by co-feeding into a furnace, along with pulverized coal, microparticles of inorganic, bubble-forming glass, ceramic, or mineral, wherein the co-fed microparticles blow to form microbubbles, and collecting the formed microbubbles.

2. The method of claim 1, wherein the weight of co-fed microparticles is at least 1% the weight of the coal.

3. The method of claim 1, wherein the weight of co-fed microparticles is less than 5% the weight of the coal.

4. The method of claim 1, wherein the co-fed microparticles comprise glass bubble precursor particles.

5. The method of claim 1, wherein the co-fed microparticles comprise amber glass.

6. The method of claim 1, wherein the co-fed microparticles comprise the mineral perlite.

7. The method of claim 1, wherein the co-fed particles comprise fused bloatable clay.

8. Hollow microsphere products made by the method of claim 1.
